(19) United States
(12) Patent Application Publication
(10) Pub. No.: US 2003/0155541 A1
(43) Pub. Date: Aug. 21, 2003

(54) Pressure enhanced diaphragm valve

(75) Inventor: Alexei Sheydayi, Gilbert, AZ (US)

Correspondence Address: Thomas D. Haverstock, HAVERSTOCK & OWENS LLP, 162 North Wolfe Road, Sunnyvale, CA, 94086, US

(73) Assignee: Supercritical Systems, Inc.

(21) Appl. No.: 10/366,030

(22) Filed: Feb. 12, 2003

Related U.S. Application Data
(60) Provisional application No. 60/357,664, filed on Feb. 15, 2002.

(51) Int. Cl. F16K 31/365

(52) U.S. Cl. 251/61; 251/282

(57) ABSTRACT

A pressure enhanced valve comprising: a diaphragm for controlling a flow of fluid media having a first pressure entering through a first chamber, the diaphragm having a first side within the first chamber wherein the first pressure is applied to the first side; and a pressure inlet for providing a second pressure to a second side of the diaphragm in a second chamber, the second side configured opposite of the first side, wherein the first chamber and the second chamber are separately sealed from one another. The first and second pressures are any appropriate amount in relation to one another. The pressure inlet supplies internal working fluid tapped from an internal port or externally supplied fluid at the second pressure. The valve further comprising a control circuit coupled to the pressure source. The valve alternatively includes a filter element and a pressure regulator positioned within the pressure inlet.

### RELATED APPLICATION

This patent application claims priority under 35 U.S.C. 119 (e) of the co-pending U.S. Provisional Patent Application Serial No. 60/357,664, filed Feb. 15, 2002, and entitled “PRESSURE ENHANCED DIAPHRAGM VALVE”. The Provisional Patent Application Serial No. 60/357,664, filed Feb. 15, 2002, and entitled “PRESSURE ENHANCED DIAPHRAGM VALVE” is also hereby incorporated by reference.

### FIELD OF THE INVENTION

The invention relates to a fluid valve in general, and specifically, to a pressure enhanced diaphragm valve for controlling flow of a high pressurized fluid therethrough.

### BACKGROUND OF THE INVENTION

Diaphragm type valves are presently used in the industry, especially in the semiconductor manufacturing area. Diaphragm valves are particularly useful in the industry, because the diaphragm valves contain a single moving part, such as a metal diaphragm, in contact with the working fluid media. Existing diaphragm valves are characterized as having a thin metal disc that is pre-bulged in the center and have a dome shape. This dome shape is sandwiched in a housing chamber and the dome is forced to snap opposite it's natural shape, thereby closing off an inlet or outlet port of the valve. When the external load is released on the diaphragm, the diaphragm naturally snaps back to its original dome shape and the inlet and outlet then have a common chamber for flow of the fluid to occur.

It is well known that the higher the operating pressure of the valve, the more stress is placed on the diaphragm. Factors limiting the life of diaphragm valves are fairly straight forward. If a metal diaphragm is flexed enough times, it will eventually fatigue and break. If the pressure is increased, the force at which the diaphragm is snapped back and forth will also rise thereby causing higher stresses in the diaphragm material. If a diaphragm is subjected to very high pressures on one side, the high pressure may permanently deform or stretch the diaphragm, rendering it useless or greatly reducing the life of the diaphragm. As higher pressures are applied to one side of the diaphragm to snap the diaphragm in one direction, the more force is required to snap the diaphragm in the opposite direction back to its original position. The current state of the art shows diaphragm valves working up to approximately 3000 psi which is classified as high pressure. To snap the diaphragm from an open position to a closed position and vice versa under such high pressures, a proportionally stiffer and stronger actuating member and piston must be used. All these factors eventually render the diaphragm valve as not having a sufficient service life to be useful and economically feasible.

What is needed is a diaphragm valve which is able to operate at higher pressures, whereby the diaphragm valve does not experience such high stresses to break, damage or deform the diaphragm.

### SUMMARY OF THE INVENTION

In one aspect of the present invention, a pressure enhanced valve comprises a diaphragm valve for controlling flow of fluid media which has a first pressure through a first chamber. The diaphragm has a first side within the first chamber, wherein the first pressure is applied to the first side. The valve comprises a pressure inlet for providing a second pressure to a second side of the diaphragm in a second chamber. The second side is configured opposite of the first side, wherein the first chamber and the second chamber are separately sealed from one another. The first and second pressures are substantially equivalent or one is greater than the other. The pressure enhanced valve further comprises a base block and a gland element that is coupled to the base block. The gland element is configured to form the first and second chamber therebetween and has a bore aperture in communication with the second chamber. The base block further comprises a first port and a second port coupled to the first chamber. The fluid media enters the first chamber from the first port and exits the first chamber through the second port. A first end of the pressure inlet is associated with the first port, whereby the fluid media is provided to the second chamber via a second end. Alternatively, the first end of the pressure inlet is associated with the second port. The gland element further comprises a moveable element that is configured to be in moveable contact with the diaphragm. The moveable element moves the diaphragm between a first position to a second position. The moveable element further comprises at least one sealing element coupled thereto, whereby the sealing element is configured to maintain the second pressure within the second chamber. The valve further comprises a pressure source, preferably external, for supplying the second pressure, whereby the pressure source is coupled to the pressure inlet. The valve further comprises a control circuit coupled to the pressure source. The valve alternatively includes a filter element and a pressure regulator positioned within the pressure inlet.

In another aspect of the present invention, a pressure enhanced valve comprises a diaphragm for controlling flow of a fluid media having a first pressure from a first port to a second port. The diaphragm is positioned within a diaphragm chamber and is configured to move between a first position and a second position. Fluid media applies the first pressure to a first side of the diaphragm. The valve comprises a pressure inlet which provides a second pressure to a second side of the diaphragm. The second side is configured opposite of the first side and is separately sealed from the first side, wherein the second pressure is applied to the second side. The first and second pressures are substantially equivalent or greater than one another. The pressure enhanced valve further comprises a base block and a gland element that is coupled to the base block. The gland element is configured to form the first and second diaphragm chambers therebetween and has a bore aperture in communication with the second side of the diaphragm. The fluid media enters the diaphragm chamber from the first port and exits the diaphragm chamber via the second port. A first end of the pressure inlet is associated with the first port, whereby the fluid media is provided to the second side via a second end. Alternatively, the first end of the pressure inlet is associated with the second port, whereby the fluid media is provided to the second side via a second end. The gland element further comprises a moveable element that is configured to be in moveable contact with the diaphragm, wherein the moveable element moves the diaphragm between the first position and the second position. The moveable element further comprises at least one sealing element coupled thereto. The sealing element is configured to maintain the second pressure against the second side. The valve further comprises a pressure source, preferably external, for supplying the second pressure, whereby the pressure source is coupled to the pressure inlet. The valve further comprises a control circuit coupled to the pressure source. The valve alternatively includes a filter element and a pressure regulator positioned within the pressure inlet.

In yet another aspect of the present invention, a pressure enhanced valve comprises means for controlling a flow of fluid media having a first pressure from a first port to a second port. The first pressure is applied to a first side of the means for controlling. The valve comprises means for applying a second pressure to a second side of the means for controlling. The first side and the second side are in separate sealed chambers.

### BRIEF DESCRIPTION OF THE DRAWINGS

FIG. 1 illustrates a perspective view of a cross section of the diaphragm valve in the open configuration in accordance with an alternate embodiment of the present invention.

FIG. 2 illustrates a schematic of a cross sectional view of the diaphragm valve having the diaphragm in an open configuration in accordance with the alternate embodiment of the present invention.

FIG. 3 illustrates a schematic of a cross sectional view of the diaphragm valve having the diaphragm in a closed configuration in accordance with the alternate embodiment of the present invention.

FIG. 4 illustrates a perspective view of a cross section of the diaphragm valve in the closed configuration in accordance with a preferred embodiment of the present invention.

FIG. 5 illustrates a schematic of a cross sectional view of the diaphragm valve having the diaphragm in an open configuration in accordance with the preferred embodiment of the present invention.

FIG. 6 illustrates a schematic of a cross section view of the diaphragm valve having the diaphragm in a closed configuration in accordance with the preferred embodiment of the present invention.

### DETAILED DESCRIPTION OF THE PRESENT INVENTION

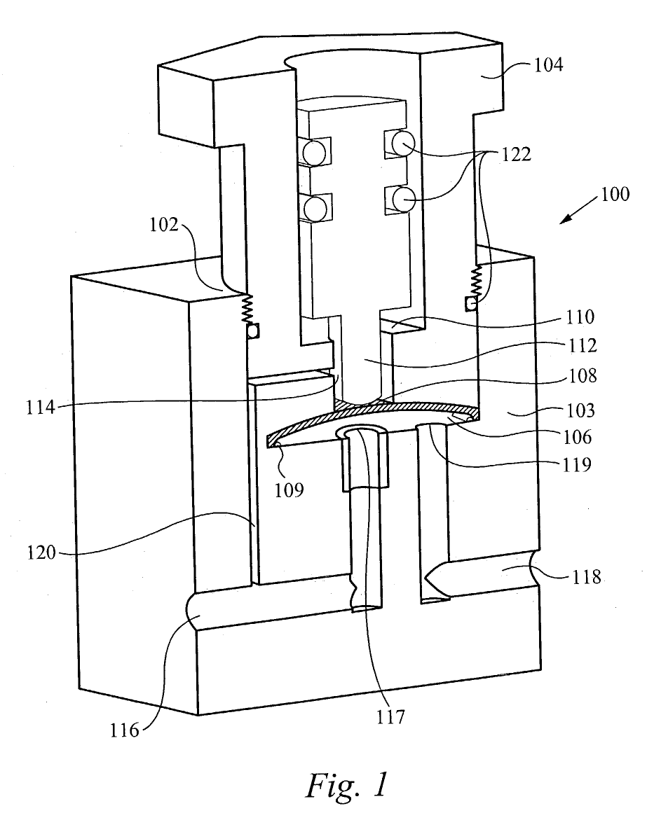

FIG. 1 illustrates a perspective view of a cross section of the diaphragm valve in the open configuration in accordance with an alternate embodiment of the present invention. As shown in FIG. 1, the valve 100 includes a body 102 which further includes a base block 103 and a gland 104. The gland 104 is in sealable engagement with the base block 103, whereby the gland 104 is threaded to the base block, as shown in FIGS. 1-6. As shown in FIGS. 1-3, the space in between the end of the gland member 104 and the receptacle area of the base block 103 forms a diaphragm chamber 106. The diaphragm chamber 106 includes an entry port 117 and an exit port 119 as well as a piston bore 110, whereby a piston 112 is configured within the piston bore 110. The gland 104 and the piston 112 include O-ring seals 122 which hold the pressure within the piston bore 110 and prevent the pressure from escaping the valve 100. The piston 112 O-rings 122 are dynamic seals which move up and down respective to the movement of the piston 112 within the piston bore 110.

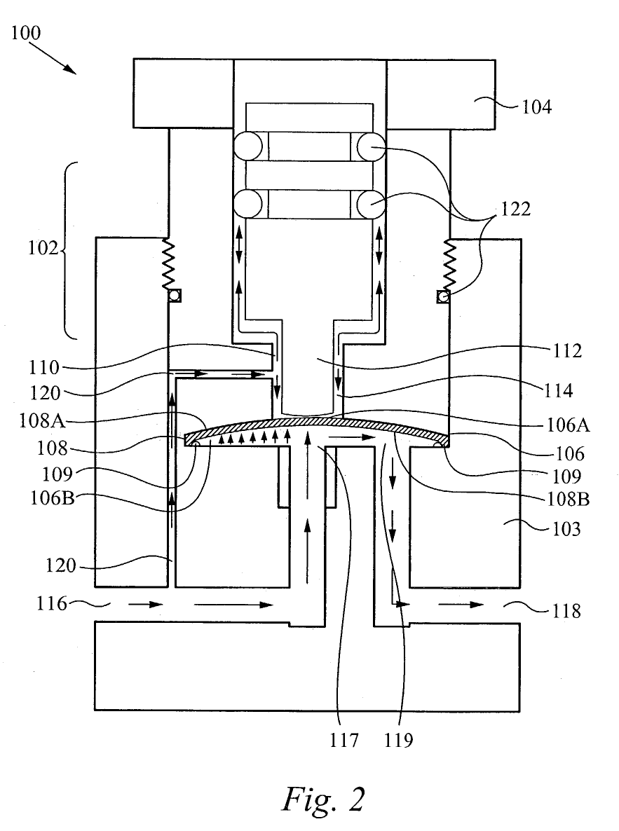

As shown in FIGS. 1-3, the valve 100 includes a diaphragm 108 positioned within the diaphragm chamber 106 and in sealable engagement with the sides of the chamber 106. In particular, the diaphragm chamber 106 has a domed shape which corresponds with the top side 108A of the diaphragm 108. As shown in FIGS. 1-6, the diaphragm 108 is sealably coupled within the diaphragm chamber 106, wherein the outer edge of the diaphragm 108 is positioned between the circular ridge member 109 and the wall of the diaphragm chamber 106. Thus, the outer edge of the diaphragm 108 is sealably wedged between the circular ridge member 109 and the wall of the diaphragm chamber 106. Alternatively, the diaphragm 108 is sealably coupled to the sides of the diaphragm chamber 106 by any other appropriate methods known in the art. The seal provided by the diaphragm 108 configures the diaphragm chamber 106 into a separately sealed space shown above the diaphragm 108, hereby designated as the top chamber 106A and a separately sealed space shown below the diaphragm 108, hereby designated as the bottom chamber 106B. Thus, the diaphragm 108 effectively forms two separately sealed chambers 106A, 106B within the diaphragm chamber 106, whereby pressurized working fluid flowing through the chamber 106 is kept separate from any matter in the top chamber 106A. The valve 100 includes an inlet port 116 and an outlet port 118, whereby pressurized fluid media flows into the valve 100 through the inlet port 116, as shown by the arrows in FIG. 2 and enters the bottom chamber 106A of the diaphragm chamber 106 through the entry port 117. In addition, the pressurized fluid media flows out of the diaphragm chamber 108 of the valve 100 through the outlet port 118 via the exit port 119.

The valve 100 of the present invention is subjected to high pressures approximately at 3000 psi, whereby the diaphragm 108 has a diameter range of 0.75 to 1.25 inches and a thickness range of 0.010 to 0.030 inches. However, it is apparent to one skilled in the art that the present valve 100 is alternatively utilized for other pressures. Therefore, for different dimensions for the diaphragm 108 would apply to accompany higher or lower pressures and is therefore not limited to the example described above. Alternatively, many diaphragms are utilized whereby the plurality of diaphragms are stacked upon one another.

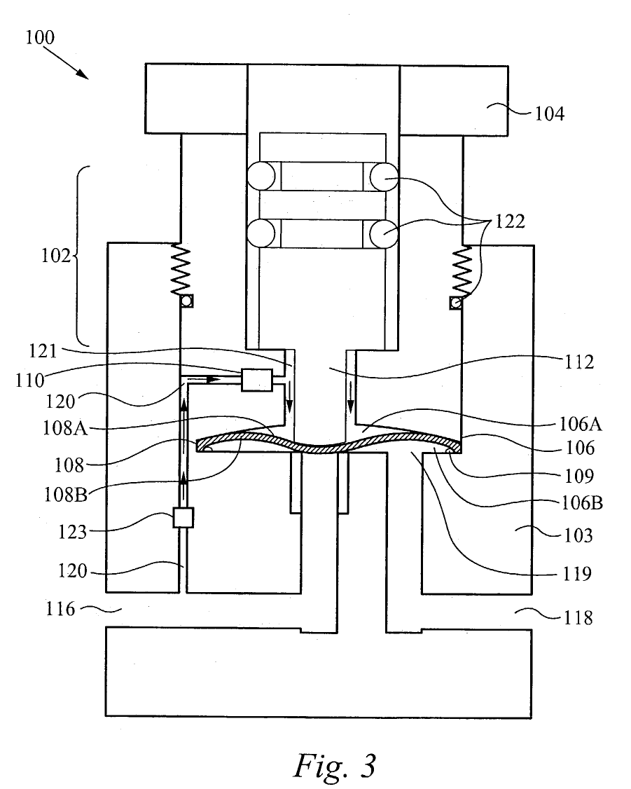

The piston 112 within the piston bore 110 is driven by an actuator (not shown) which actuates the piston 112 between the opened and closed positions. The actuator (not shown) is known in the art and any known actuator is used to force the piston 112 upward and/or downward. The piston 112 actuates the diaphragm 108 to move between the open configuration, as shown in FIG. 2, and the closed configuration, as shown in FIG. 3. The diaphragm 108 is shaped to be in the open position when the piston is not applying a force on the diaphragm 108, whereby the top surface 108A of the diaphragm 108 corresponds to the dome shaped diaphragm chamber 106. To shut the valve 100 and thereby control the flow of the fluid media through the diaphragm chamber 106, the piston 112 moves downward and applies a downward force to the diaphragm 108, as shown in FIG. 3. The downward force of the piston 112 onto the diaphragm 108 causes the diaphragm 108 to bulge inward and press onto the inlet port 117, as shown in FIG. 3. Thus, the diaphragm 108 pressed onto the inlet port 117 prevents the flow of fluid media from entering the diaphragm chamber 106.

When the force applied to the piston 112 is terminated, the piston 112 moves upward and releases the load on the diaphragm 108. The release of the force on the diaphragm 108 causes the diaphragm 108 to automatically snap back to its natural, bulged shape (FIG. 2), thereby allowing flow of the fluid media to enter into the diaphragm chamber 106 via the inlet port 117. It is contemplated that the piston 112 and diaphragm 108 configuration is not limited to the example discussed herein and alternatively operate in the reverse direction.

In the alternative embodiment, the valve 100 of the present invention includes a pressure inlet port 120 to assist the piston 112 and actuator (not shown) in applying force to the diaphragm 108. As shown in FIGS. 1-3, the pressure port 120 is tapped into the inlet port 116 and is routed within the gland 104 to a predetermined location in the piston bore 110. In this alternate embodiment, the pressure port 120 supplies pressurized working fluid entering the valve 100 to the piston bore 110, as shown in FIGS. 2 and 3. The pressurized fluid passes through the pressure port 120 and eventually fills the piston bore 110 as well as the top chamber 106A. The pressurized working fluid thereby applies the pressurized force of the working fluid to the top face 108A of the diaphragm 108. Effectively, the pressure port 120 supplies the pressurized fluid media to the top chamber 106A to assist the piston 112 and actuator (not shown) in actuating the diaphragm 108.

In the alternate embodiment, the amount of pressure supplied to the piston bore 1110 and top chamber 106A as well as the top side 108A of the diaphragm 108 is equivalent or substantially equivalent to the amount of pressure present in the bottom chamber 106B. This, in effect, forms substantially equal pressure in the top chamber 106A and bottom chamber 106B, thereby creating a negligible pressure differential between the top 108A and bottom 108B surfaces of the diaphragm 108. As a result, the pressurized fluid in the piston bore 110 and top chamber 106A assists the actuator (not shown) and piston 112 in shutting off the flow of pressurized fluid media entering the bottom chamber 106B. In other words, the actuator (not shown) and piston 112 would not require as much force to press the diaphragm 108 to the closed position, due to substantially the same amount of pressure being applied to the opposite sides of the diaphragm. Additionally, the pressurized working fluid in the piston bore 100 and top chamber 106A applies the pressure to the top surface 108A of the diaphragm 108.

The alternate embodiment shown in FIGS. 1-3 illustrates the pressure port 120 coupled to the inlet port 116. However, it is apparent to one skilled in the art that the pressure port 120 is alternatively coupled to the outlet port 118. In addition, a pressure regulator 123 is alternatively utilized within the present valve, whereby the pressure regulator 123 is positioned within the pressure inlet 120. Although this design allows the diaphragm valve 100 to operate at very high pressures that are far beyond valves in the current state of the art, contaminants in the fluid media may be able to flow into the top chamber 108A of the valve. Thus, as shown in FIG. 3, a filter element 121 is employed within the pressure port 120 to enhance the cleanliness of the fluid.

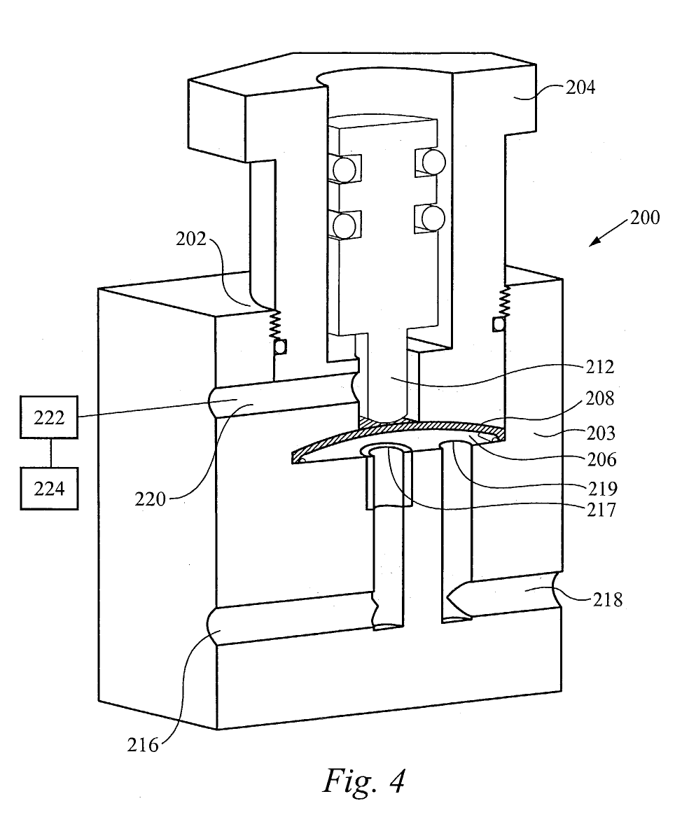

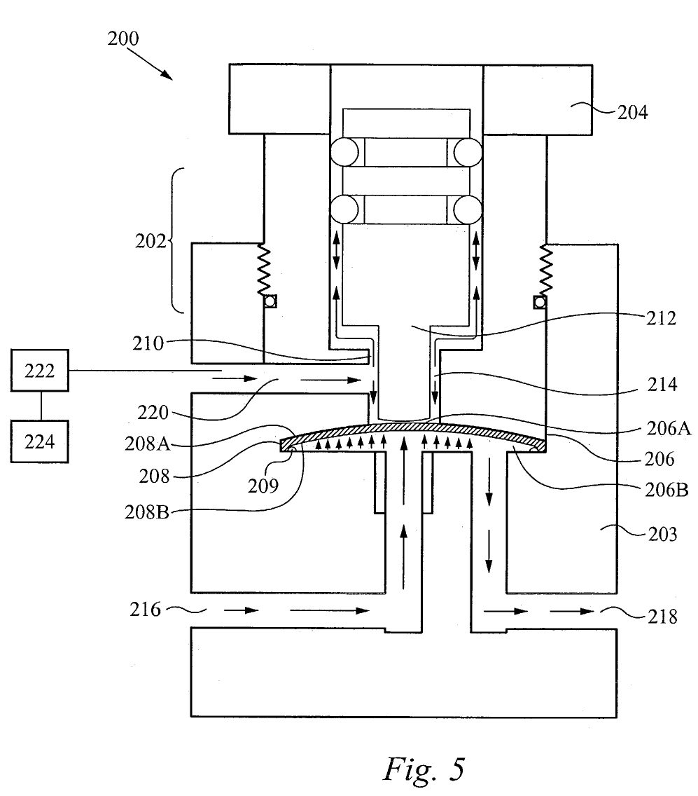

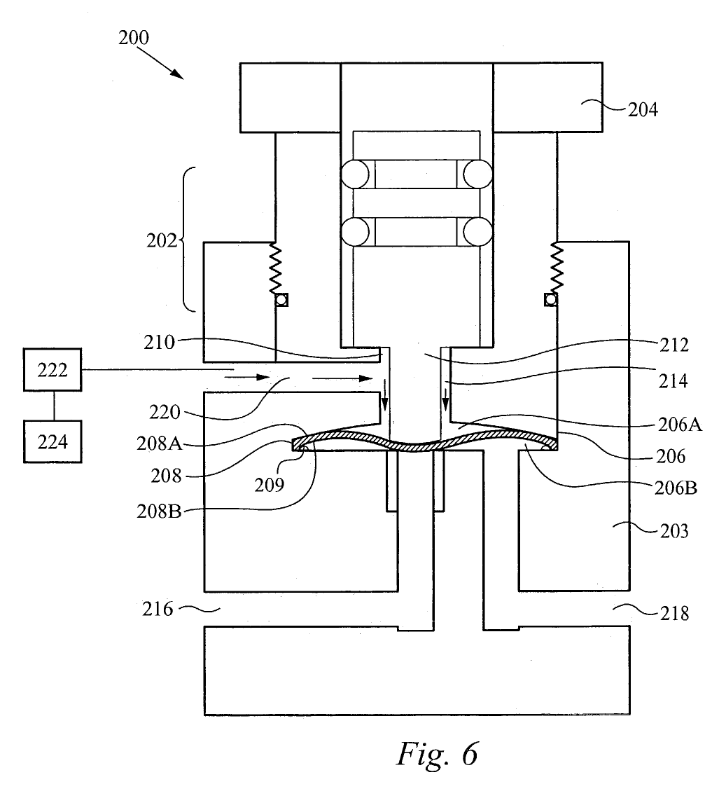

FIG. 4 illustrates a perspective view of a cross section of the diaphragm valve in the closed configuration in accordance with a preferred embodiment of the present invention. The preferred embodiment of the valve 200 has the same configuration as in the alternative embodiment shown in FIGS. 1-3. However, unlike the alternative embodiment which aids in moving the diaphragm 108 (FIGS. 1-3) using pressure from the inlet port 116 (FIGS. 1-3) and alternatively the outlet port 118 (FIGS. 1-3), the preferred embodiment includes a separate external pressure port 220 within the gland 204, as shown in FIG. 4. The external pressure port 220 supplies pressure to the top chamber 206A and the top surface 208A of the diaphragm 108 to assist in driving the diaphragm 108 from the open position (FIG. 5) to the closed position (FIG. 6).

A pressure generating device 224 is coupled to the external pressure port 220 and supplies pressure thereto. Any known device (not shown) used to generate the pressure is utilized in the present invention and will not be discussed in detail herein. The preferred embodiment utilizes pressurized air, carbon dioxide or other gases rather than the working fluid media. Alternatively, working fluid media or another appropriate pressurized fluid is supplied to the top chamber 206A of the valve 200. The external pressure port 220 and the pressure generating device 224 is coupled to a control circuit 222 whereby the control circuit 222 controls the amount of pressure that is generated or supplied to the piston bore 210 and the top chamber 206A.

As described above, the external pressure supplied to the top chamber 206A and the topside of the diaphragm 208 is equal or substantially equal to the pressure of the working fluid which flows into the bottom chamber 206B. As stated above, the pressurized matter that is supplied via the external pressure port 220 is a gas-like substance having little or no particulate matter. Therefore, the preferred embodiment has an advantage of using a low purity supply, whereby there is little or no concern with particulate matter getting trapped inside the valve 200 or contaminating the working fluid media in the bottom chamber 206B of the system 200.

In another instance, the amount of external pressure supplied to the piston bore 210 and top chamber 206A is below the pressure of the working fluid entering the diaphragm chamber 208 of the valve 200. The valve 200 operates by increasing the pressure in the top chamber 206A to be above the pressure of the working fluid in the bottom chamber 206B. The increase in pressure in the top chamber 206A causes the pressure forces applied to the top surface 208A to push the diaphragm 208 downward, thereby shutting the flow of fluid through the valve 200. The increase in pressure is controlled by the control circuit 222 which senses the pressures in the top and bottom chambers 206A, 206B and accordingly increases and decreases the pressure supplied to the piston bore 210 and top chamber 206A. In addition, the additional topside pressure reduces the amount of force needed by the actuator (not shown) or eliminates the need for an actuator.

In another instance, the external pressure port 220 supplies pressure to the top chamber 206A and topside 208A of the diaphragm 208 which is greater than the pressure of the working fluid media in the bottom chamber 206B. This instance is useful in applications in which the valve 200 is subjected to a high pressure shock caused by extremely high initial pressures from the working fluid entering the bottom chamber 206B through the entry port 217. This initial high pressure shock can cause the diaphragm 208 to quickly buckle, deform or collapse under such a sudden pressure change. To counteract or diminish the initial high pressure shock experienced by the diaphragm 208, higher pressure is initially supplied to the top chamber 206A and provides adequate support to the topside 208A of the diaphragm 208. The external pressure applied to the topside 208A of the diaphragm 208 thereby prevents the diaphragm 208 from buckling or collapsing due to the extremely high initial pressure in the bottom chamber 206B. Thereafter, as the valve 200 begins to open or close, the control circuit 222 either increases or decreases the pressure in the top chamber 206A, depending on the amount of pressure of the working fluid.

In another instance, the valve 200 is initially in the closed position (FIG. 6), whereby the pressure in the top chamber 206A is initially greater than the pressure in the bottom chamber 206B. However, as more pressurized working fluid enters the bottom chamber 206B and comes into to contact with the bottom side 208B of the diaphragm 208, the pressure in the bottom chamber 206B eventually becomes greater than the pressure in the top chamber 206A. Once that condition occurs, the working fluid in the bottom chamber 206B forces the diaphragm 208 to snap into the open position (FIG. 6). The control circuit 222, when shutting the flow of fluid through the valve 200, increases the amount of pressure supplied by the external pressure source 224 to the top chamber 206A. The increase in pressure applied to the topside of the diaphragm 208 causes the diaphragm 208 to snap back into the closed position, thereby effectively shutting off the flow of working fluid into the bottom chamber 206B. The control circuit 222, when opening the flow of fluid through the valve 200, decreases the amount of pressure supplied to the top chamber 206A, such that the greater pressure in the bottom chamber 206B causes the diaphragm 208 to snap back to the open position. This, in effect allows the present diaphragm valve 200 to act as a “Pressure Regulator” or “Pressure Relief Device”. Alternatively, the particular embodiment of the valve 200 operates with the piston 212 and/or actuator (not shown), whereby less pressure is provided to the topside of the diaphragm 208 and top chamber 206A to actuate the diaphragm 208. It should also be noted that although many different applications of the present diaphragm valve 200 have been discussed, the present diaphragm valve 200 may alternatively be used in other applications not discussed herein.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

What is claimed is:

1. A pressure enhanced valve comprising:
a. a diaphragm for controlling a flow of fluid media having a first pressure into a first chamber, the diaphragm having a first side within the first chamber wherein the first pressure is applied to the first side; and
b. a pressure inlet for providing a second pressure to a second side of the diaphragm in a second chamber, the second side configured opposite of the first side, wherein the first chamber and the second chamber are separately sealed from one another.

2. The pressure enhanced valve according to claim 1 wherein the first and second pressures are substantially equivalent.

3. The pressure enhanced valve according to claim 1 wherein the first pressure is greater than the second pressure.

4. The pressure enhanced valve according to claim 1 wherein the second pressure is greater than the first pressure.

5. The pressure enhanced valve according to claim 1 further comprising:
a. a base block; and
b. a gland element coupled to the base block and configured to form the first and second chamber therebetween, the gland element having a bore aperture in communication with the second chamber.

6. The pressure enhanced valve according to claim 5 wherein the base block further comprises a first conduit and a second conduit coupled to the first chamber, wherein the fluid media enters the first chamber via the first conduit and exits the first chamber via the second conduit.

7. The pressure enhanced valve according to claim 6 wherein a first end of the pressure inlet is associated with the first conduit, whereby the fluid media is provided to the second chamber via a second end.

8. The pressure enhanced valve according to claim 6 wherein a first end of the pressure inlet is associated with the second conduit, whereby the fluid media is provided to the second chamber via a second end.

9. The pressure enhanced valve according to claim 5 wherein the gland element further comprises a moveable element configured to be in moveable contact with the diaphragm, wherein the moveable element moves the diaphragm between a first position to a second position.

10. The pressure enhanced valve according to claim 9 wherein the moveable element further comprises at least one sealing element coupled thereto, the sealing element configured to maintain the second pressure within the second chamber.

11. The pressure enhanced valve according to claim 1 further comprising a pressure source for supplying the second pressure.

12. The pressure enhanced valve according to claim 11 further comprising a control circuit coupled to the pressure source.

13. The pressure enhanced valve according to claim 11 wherein the pressure source is externally employed to the valve.

14. The pressure enhanced valve according to claim 1 further comprising a filter element positioned within the pressure inlet.

15. The pressure enhanced valve according to claim 1 further comprising a pressure regulator positioned within the pressure inlet.

16. A pressure enhanced valve comprising:
a. a diaphragm for controlling a flow of fluid media having a first pressure from a first port to a second port, the diaphragm positioned within a diaphragm chamber and configured to move between a first position and a second position, wherein the fluid media applies the first pressure to a first side of the diaphragm; and
b. a pressure inlet for providing a second pressure to a second side of the diaphragm, the second side configured opposite of the first side and separately sealed from the first side.

17. The pressure enhanced valve according to claim 16 wherein the first and second pressures are substantially equivalent.

18. The pressure enhanced valve according to claim 16 wherein the first pressure is greater than the second pressure.

19. The pressure enhanced valve according to claim 16 wherein the second pressure is greater than the first pressure.

20. The pressure enhanced valve according to claim 16 further comprising:
a. a base block; and
b. a gland element coupled to the base block and configured to form the first diaphragm chamber and the second diaphragm chamber therebetween, the gland element having a bore aperture in communication with the second side of the diaphragm.

21. The pressure enhanced valve according to claim 20 wherein the fluid media enters the diaphragm chamber via a first conduit and exits the diaphragm chamber via the second conduit.

22. The pressure enhanced valve according to claim 21 wherein a first end of the pressure inlet is associated with the first conduit, whereby the fluid media is provided to the second side via a second end.

23. The pressure enhanced valve according to claim 21 wherein a first end of the pressure inlet is associated with the second conduit, whereby the fluid media is provided to the second side via a second end.

24. The pressure enhanced valve according to claim 20 wherein the gland element further comprises a moveable element configured to be in moveable contact with the diaphragm, wherein the moveable element moves the diaphragm between the first position and the second position.

25. The pressure enhanced valve according to claim 24 wherein the moveable element further comprises at least one sealing element coupled thereto, the sealing element configured to maintain the second pressure against the second side.

26. The pressure enhanced valve according to claim 16 further comprising a pressure source for supplying the second pressure via the pressure inlet.

27. The pressure enhanced valve according to claim 26 further comprising a control circuit coupled to the pressure source.

28. The pressure enhanced valve according to claim 26 wherein the pressure source is externally employed to the valve.

29. The pressure enhanced valve according to claim 16 further comprising a filter element positioned within the pressure inlet.

30. The pressure enhanced valve according to claim 16 further comprising a pressure regulator positioned within the pressure inlet.

31. A pressure enhanced valve comprising:
a. means for controlling a flow of fluid media having a first pressure from a first port to a second port, wherein the first pressure is applied to a first side of the means for controlling; and
b. means for providing a second pressure to a second side of the means for controlling, wherein the first side and the second side are in separate sealed chambers.
